(19) United States
(12) Patent Application Publication
(10) Pub. No.: US 2013/0015373 A1
(43) Pub. Date: Jan. 17, 2013

(54) EUV Radiation Source and EUV Radiation Generation Method

(71) Applicants: Andrei Mikhailovich Yakunin, Eindhoven (NL); Vadim Yevgenyevich Banine, Deurne (NL); Vladimir Vitalevich Ivanov, Moscow (RU); Konstantin Nikolaevich Koshelev, Moscow (RU); Vladimir Mihailovitch Krivtsun, Moscow (RU); Denis Alexandrovich Glushkov, Alfter (DE)

(72) Inventors: Andrei Mikhailovich Yakunin, Eindhoven (NL); Vadim Yevgenyevich Banine, Deurne (NL); Vladimir Vitalevich Ivanov, Moscow (RU); Konstantin Nikolaevich Koshelev, Moscow (RU); Vladimir Mihailovitch Krivtsun, Moscow (RU); Denis Alexandrovich Glushkov, Alfter (DE)

(73) Assignee: ASML Netherlands B.V.

(21) Appl. No.: 13/583,986

(22) PCT Filed: Mar. 8, 2011
(86) PCT No.: PCT/EP2011/053432

§ 371 Date: Sep. 11, 2012

Related U.S. Application Data
(60) Provisional application No. 61/322,114, filed on Apr. 8, 2010.
(60) Provisional application No. 61/363,720, filed on Jul. 13, 2010.

(51) Int. Cl. G21K 5/00

(52) U.S. Cl. 250/492.1; 250/494.1

(57) ABSTRACT

An EUV radiation source comprising a fuel supply (200) configured to deliver a droplet of fuel to a plasma generation location (201), a first laser beam source configured to provide a first beam of laser radiation (205) incident upon the fuel droplet at the plasma generation location and thereby vaporizes the fuel droplet, and a second laser beam source configured to subsequently provide a second beam of laser radiation (205) at the plasma generation location, the second beam of laser radiation being configured to vaporize debris particles (252) arising from incomplete vaporization of the fuel droplet.

### CROSS-REFERENCE TO RELATED APPLICATIONS

The present invention claims the benefit of U.S. provisional application 61/322,114, filed on 8 Apr. 2010, and U.S. provisional application 61/363,720, filed on 13 Jul. 2010. Both these provisional appliciations are hereby incorporated in their entirety by reference.

### FIELD

The present invention relates to an EUV radiation source and an EUV radiation generation method. The EUV radiation source may form part of a lithographic apparatus.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g., comprising part of, one, or several dies) on a substrate (e.g., a silicon wafer). Transfer of the pattern is typically via imaging onto a layer of radiation-sensitive material (resist) provided on the substrate. In general, a single substrate will contain a network of adjacent target portions that are successively patterned.

Lithography is widely recognized as one of the key steps in the manufacture of ICs and other devices and/or structures. However, as the dimensions of features made using lithography become smaller, lithography is becoming a more critical factor for enabling miniature IC or other devices and/or structures to be manufactured.

A theoretical estimate of the limits of pattern printing can be given by the Rayleigh criterion for resolution as shown in equation (1):

$$CD = {k}_{1} * \frac{λ}{NA}$$

where λ is the wavelength of the radiation used, NA is the numerical aperture of the projection system used to print the pattern, k₁ is a process dependent adjustment factor, also called the Rayleigh constant, and CD is the feature size (or critical dimension) of the printed feature. It follows from equation (1) that reduction of the minimum printable size of features can be obtained in three ways: by shortening the exposure wavelength λ, by increasing the numerical aperture NA or by decreasing the value of k₁.

In order to shorten the exposure wavelength and, thus, reduce the minimum printable size, it has been proposed to use an extreme ultraviolet (EUV) radiation source. EUV radiation is electromagnetic radiation having a wavelength within the range of 5-20 nm, for example within the range of 13-14 nm, for example within the range of 5-10 nm such as 6.7 nm or 6.8 nm. Possible sources include, for example, laser-produced plasma sources, discharge plasma sources, or sources based on synchrotron radiation provided by an electron storage ring.

EUV radiation may be produced using a plasma. A radiation system for producing EUV radiation may include a laser for exciting a fuel to provide the plasma, and a source collector module for containing the plasma. The plasma may be created, for example, by directing a laser beam at a fuel, such as particles of a suitable material (e.g., tin), or a stream of a suitable gas or vapor, such as Xe gas or Li vapor. The resulting plasma emits output radiation, e.g., EUV radiation, which is collected using a radiation collector. The radiation collector may be a mirrored normal incidence radiation collector, which receives the radiation and focuses the radiation into a beam. The source collector module may include an enclosing structure or chamber arranged to provide a vacuum environment to support the plasma. Such a radiation system is typically termed a laser produced plasma (LPP) source.

When the laser beam is incident upon the fuel, vaporisation of the fuel may be incomplete. Thus, part of the fuel is converted into debris particles rather than being converted into a vapor. The debris particles are undesirable since they may be incident upon the collector or other optical surfaces within the lithographic apparatus, and may reduce the reflectivity of the collector or other optical surfaces.

### SUMMARY

It is desirable to reduce the amount of debris particles that is incident upon the collector or other optical surfaces of the lithographic apparatus.

According to an aspect of the invention, there is provided an EUV radiation source comprising a fuel supply configured to deliver a droplet of fuel to a plasma generation location. A first laser beam source is configured to provide a first beam of laser radiation that is incident upon the fuel droplet at the plasma generation location and thereby vaporizes the fuel droplet to generate an EUV radiation emitting plasma. A second laser beam source is configured to subsequently provide a second beam of laser radiation at the plasma generation location. The second beam of laser radiation is configured to vaporize debris particles arising from incomplete vaporization of the fuel droplet. The second laser beam source may be configured to generate the second beam of laser radiation with a wavelength of 100 nanometers or longer.

According to a second aspect of the invention there is provided a method of generating EUV radiation comprising delivering a droplet of fuel to a plasma generation location, vaporizing the fuel droplet by directing a first beam of laser radiation at the plasma generation location to generate an EUV radiation emitting plasma, then subsequently vaporizing debris particles arising from incomplete vaporization of the fuel droplet by directing a second beam of laser radiation at the plasma generation location.

The first beam of laser radiation may be pulsed and the second beam of laser radiation may be pulsed. The beginning of a radiation pulse of the second beam of laser radiation may be incident at the plasma generation location 100 nanoseconds or more after the beginning of a radiation pulse of the first beam of laser radiation. A radiation pulse of the second beam of laser radiation may be incident at the plasma generation location after the plasma has decayed. The second beam of laser radiation may subtend an angle of 30° or less relative to an optical axis of the EUV radiation source.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts the lithographic apparatus of FIG. 1 in more detail;

FIG. 3 is a schematic view of part of the source collector module of the lithographic apparatus at a particular moment in time; and

FIG. 4 is a schematic view of the same part of the source collector module at a later moment in time.

### DETAILED DESCRIPTION

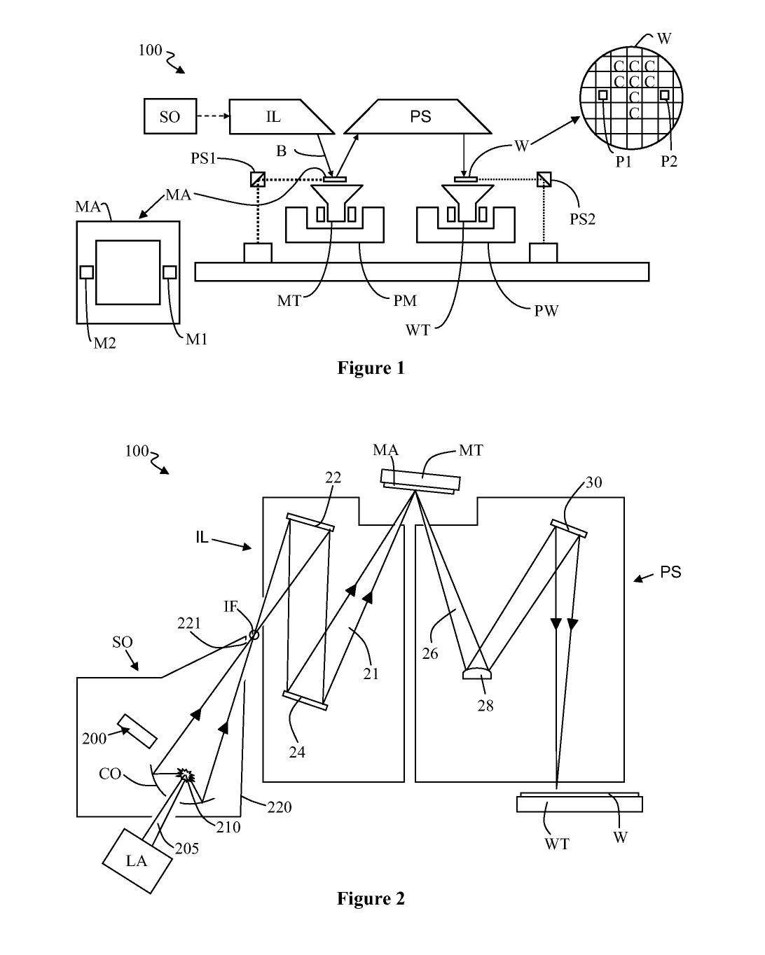

FIG. 1 schematically depicts a lithographic apparatus 100 including a source collector module SO according to one embodiment of the invention. The apparatus comprises:
an illumination system (illuminator) IL configured to condition a radiation beam B (e.g., EUV radiation);
a support structure (e.g., a mask table) MT constructed to support a patterning device (e.g., a mask or a reticle) MA and connected to a first positioner PM configured to accurately position the patterning device;
a substrate table (e.g., a wafer table) WT constructed to hold a substrate (e.g., a resist-coated wafer) W and connected to a second positioner PW configured to accurately position the substrate; and
a projection system (e.g., a reflective projection system) PS configured to project a pattern imparted to the radiation beam B by patterning device MA onto a target portion C (e.g., comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure MT holds the patterning device MA in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system.

The term “patterning device” should be broadly interpreted as referring to any device that can be used to impart a radiation beam with a pattern in its cross-section such as to create a pattern in a target portion of the substrate. The pattern imparted to the radiation beam may correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam that is reflected by the mirror matrix.

The projection system, like the illumination system, may include various types of optical components, such as refractive, reflective, magnetic, electromagnetic, electrostatic or other types of optical components, or any combination thereof, as appropriate for the exposure radiation being used, or for other factors such as the use of a vacuum. It may be desired to use a vacuum for EUV radiation since gases may absorb too much radiation. A vacuum environment may therefore be provided to the whole beam path with the aid of a vacuum wall and vacuum pumps.

As here depicted, the apparatus is of a reflective type (e.g., employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

Referring to FIG. 1, the illuminator IL receives an extreme ultraviolet (EUV) radiation beam from the source collector module SO. Methods to produce EUV radiation include, but are not necessarily limited to, converting a material into a plasma state that has at least one element, e.g., xenon, lithium or tin, with one or more emission lines in the EUV range. In one such method, often termed laser produced plasma (“LPP”) the required plasma can be produced by irradiating a fuel with a laser beam. Fuel may for example be a droplet, stream or cluster of material having the required line-emitting element. The source collector module SO may be part of an EUV radiation system including a laser, not shown in FIG. 1, for providing the laser beam that excites the fuel. The resulting plasma emits output radiation, e.g., EUV radiation, which is collected using a radiation collector located in the source collector module. The laser and the source collector module may be separate entities, for example when a CO₂ laser is used to provide the laser beam for fuel excitation. In such cases, the laser is not considered to form part of the lithographic apparatus, and the radiation beam is passed from the laser to the source collector module with the aid of a beam delivery system comprising, for example, suitable directing mirrors and/or a beam expander. In other cases the source may be an integral part of the source collector module, for example when the source is a discharge produced plasma EUV generator, often termed as a DPP source.

The illuminator IL may comprise an adjuster for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as facetted field and pupil mirror devices. The illuminator may be used to condition the radiation beam, to have a desired uniformity and intensity distribution in its cross-section.

The radiation beam B is incident on the patterning device (e.g., mask) MA, which is held on the support structure (e.g., mask table) MT, and is patterned by the patterning device. After being reflected from the patterning device (e.g., mask) MA, the radiation beam B passes through the projection system PS, which focuses the beam onto a target portion C of the substrate W. With the aid of the second positioner PW and position sensor PS2 (e.g., an interferometric device, linear encoder or capacitive sensor), the substrate table WT can be moved accurately, e.g., so as to position different target portions C in the path of the radiation beam B. Similarly, the first positioner PM and another position sensor PS1 can be used to accurately position the patterning device (e.g., mask) MA with respect to the path of the radiation beam B. Patterning device (e.g., mask) MA and substrate W may be aligned using mask alignment marks M1, M2 and substrate alignment marks P1, P2.

The depicted apparatus could be used in at least one of the following modes:

1. In step mode, the support structure (e.g., mask table) MT and the substrate table WT are kept essentially stationary, while an entire pattern imparted to the radiation beam is projected onto a target portion C at one time (i.e., a single static exposure). The substrate table WT is then shifted in the X and/or Y direction so that a different target portion C can be exposed.

2. In scan mode, the support structure (e.g., mask table) MT and the substrate table WT are scanned synchronously while a pattern imparted to the radiation beam is projected onto a target portion C (i.e., a single dynamic exposure). The velocity and direction of the substrate table WT relative to the support structure (e.g., mask table) MT may be determined by the (de-)magnification and image reversal characteristics of the projection system PS.

3. In another mode, the support structure (e.g., mask table) MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

FIG. 2 shows the apparatus 100 in more detail, including the source collector module SO, the illumination system IL, and the projection system PS. The source collector module SO is constructed and arranged such that a vacuum environment can be maintained in an enclosing structure 220 of the source collector module SO.

A laser LA is arranged to deposit laser energy via a laser beam 205 into a fuel, such as xenon (Xe), tin (Sn) or lithium (Li) that is provided from a fuel supply 200, thereby creating a highly ionized plasma 210 with electron temperatures of several 10's of eV. The energetic radiation generated during de-excitation and recombination of these ions is emitted from the plasma, collected and focussed by a near normal incidence collector CO.

Radiation that is reflected by the collector CO is focused in a virtual source point IF. The virtual source point IF is commonly referred to as the intermediate focus, and the source collector module SO is arranged such that the intermediate focus IF is located at or near an opening 221 in the enclosing structure 220. The virtual source point IF is an image of the radiation emitting plasma 210.

Subsequently the radiation traverses the illumination system IL. The illumination system IL may include a facetted field mirror device 22 and a facetted pupil mirror device 24 arranged to provide a desired angular distribution of the radiation beam 21 at the patterning device MA, as well as a desired uniformity of radiation intensity at the patterning device MA. Upon reflection of the beam of radiation 21 at the patterning device MA, a patterned beam 26 is formed and the patterned beam 26 is imaged by the projection system PS via reflective elements 28, 30 onto a substrate W held by the substrate table WT.

More elements than shown may generally be present in the illumination system IL and projection system PS. Further, there may be more mirrors present than those shown in the Figures, for example there may be 1-6 additional reflective elements present in the projection system PS than shown in FIG. 2.

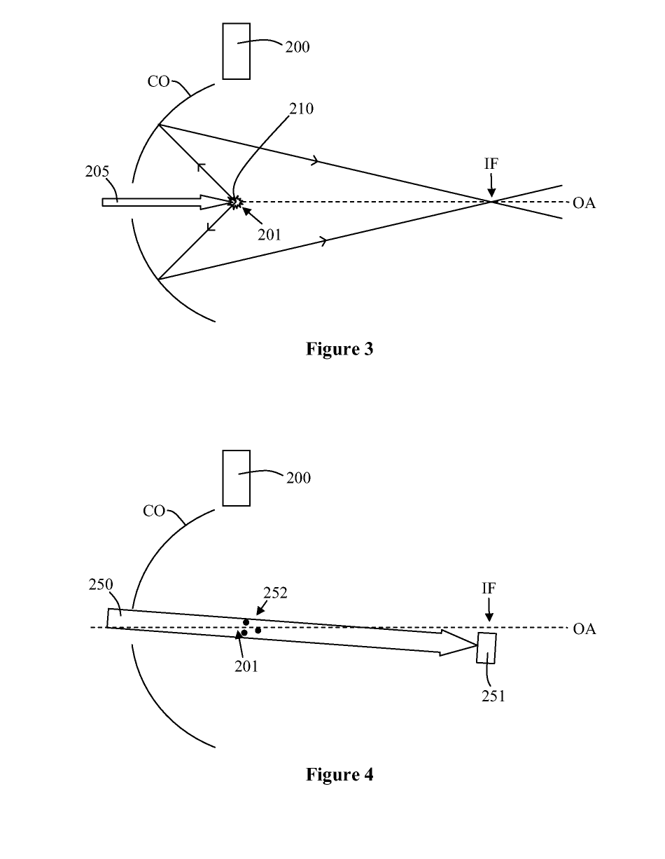

FIG. 3 is a larger schematic view of part of the source collector module SO of FIG. 2. Referring to FIG. 3, the fuel supply 200 has delivered a droplet of fuel (e.g., tin) to a plasma generation location 201, which is positioned at a focus of the collector CO. The laser beam 205 is incident upon the fuel droplet, thereby causing the fuel droplets to vaporize. The resulting plasma 210 emits EUV radiation that is collected by the collector CO and focused at an intermediate focus IF (the second focus of the collector). The EUV radiation passes from the intermediate focus IF into the illumination system of the lithographic apparatus (see FIG. 2). The optical axis OA of the source collector module is indicated by a dashed line in FIG. 3.

FIG. 3 attempts to schematically show the situation at a moment in time when the laser beam 205 is incident upon the fuel droplet and the fuel droplet has begun to form the plasma 210.

FIG. 4 shows the same apparatus as FIG. 3, but at a later moment in time. In FIG. 4 the laser beam 205 is no longer incident at the plasma generation location. Since some time has elapsed, the plasma has decayed and is no longer present. The laser beam 205 (referred to hereafter as the first laser beam 205) is no longer incident at the plasma generation location 201. However, a second laser beam 250 is now incident at the plasma generation location 201. As may be seen from FIG. 4, the second laser beam 250 travels beyond the plasma generation location and is incident upon a beam stop 251, which is located adjacent to the intermediate focus IF.

The second laser beam 250 has a diameter that is larger than the first laser beam 205 shown in FIG. 3. In this embodiment the second laser beam 250 does not lie on the optical axis OA but instead subtends an angle relative to the optical axis. The purpose of the second laser beam 250 is to vaporize debris particles that was generated during incomplete vaporisation of the fuel droplet by the first laser beam 205. Debris particles 252 are shown schematically in FIG. 4. The size of the debris particles is exaggerated in FIG. 4 in order to make it visible.

The second laser beam 250 may have sufficient power and a sufficient diameter to vaporize a significant proportion of debris particles 252. Vaporisation of the debris particles is advantageous, since the debris particles, once vaporized, will not give rise to contamination on the collector CO or other optical surfaces of the lithographic apparatus.

The second laser beam 250 may be pulsed, thereby enabling higher intensity radiation to be delivered to the plasma generation location 201 (compared with if the laser beam was provided continuously). Higher intensity radiation will provide more complete vaporization of debris particles than lower intensity radiation. The second laser beam 250 may for example have a pulse duration of 10 nanoseconds or greater. The second laser beam may for example have a pulse duration of 10 microseconds or less.

As may be inferred from FIGS. 3 and 4, there may be a time delay between the first laser beam 205 being incident at the plasma generation location and the second laser beam 250 being incident at the plasma generation location. The time delay may take into account various factors arising from the manner in which the fuel droplet is vaporized by the first laser beam 205. Although the precise manner in which the fuel droplet vaporizes is not fully known, it is believed that the vaporisation process may be as follows. The first laser beam 205 is incident upon one side of the fuel droplet (in this example the fuel is tin). Small particles of tin are ablated from the surface of the fuel droplet and travel away from the fuel droplet. Energy is absorbed by the fuel droplet, causing the fuel droplet to increase in temperature and expand. The fuel droplet continues to expand and then breaks apart. A portion of the fuel droplet is vaporized as the fuel droplet breaks apart, forming the EUV radiation emitting plasma. The portion of the fuel droplet that does not vaporize forms debris particles 252 of tin having various sizes.

It may be the case that the fuel droplet breaks into pieces and vaporizes after the first laser beam 205 has ceased to be incident upon the fuel droplet. This may depend upon the pulse duration of the first laser beam 205.

Small debris particles will travel more quickly than larger debris particles. These small debris particles may have been generated during initial ablation of the fuel droplet. Due to the early formation of the small debris particles and their high speed (e.g., up to 1000 m/s), at a given moment in time these droplets will be further from the plasma generation location 201 than larger debris particles. The larger debris particles will have been generated later and will have lower speeds.

It is believed that debris particles do not spread out from the plasma generation location 201 equally in all directions. Instead, it is believed that a greater proportion of debris particles may travel in the general direction of the intermediate focus IF (compared with other directions). It is for this reason that the second laser beam 250 has an orientation such that it provides a significant overlap with the optical axis OA of the source collector module. This is illustrated schematically in FIG. 4, which shows the second laser beam 250 passing through the plasma generation location 201, and providing significant overlap with the optical axis OA beyond the plasma generation location. In alternative embodiments of the invention the second laser beam 250 may be directed at the plasma generation location 201 with any orientation. However, some orientations may provide less vaporisation of debris particles compared with that provided by the illustrated embodiment (or other embodiments that provide a significant overlap of the second laser beam 250 with the optical axis OA).

In an embodiment the second laser beam 250 may be co-axial with the first laser beam 205. However, in order to achieve this it may be necessary to provide a beam splitter or other optics in the beam path of the first laser beam 205, which may cause an undesirable reduction of the power of the first laser beam 205 incident at the plasma generation location 201. As shown in FIG. 4, the second laser beam 250 may be provided at a small angle relative to the optical axis OA of the source collector module, thereby avoiding the need to provide optics that introduce the second laser beam 250 in the beam path of the first laser beam 205. The small angle relative to the optical axis may for example be less than 30°, less than 20°, or less than 10°.

Providing the second laser beam 250 at a small angle relative to the optical axis OA of the source collector module provides the advantage that those debris particles 252 that are travelling towards the intermediate focus IF (and hence to reflectors of the illumination system IL) spend the longest period of time within the second laser beam. It is desirable to vaporize these debris particles in particular, in order to avoid them being incident upon reflectors of the illumination system IL and reducing the reflectivity of those reflectors.

There is a delay between the time at which the first laser beam 205 is initially incident upon the fuel droplet at the plasma generation location 201, and the time at which the second laser beam 250 is incident at the plasma generation location 201. The time delay may be measured from the beginning of a pulse of the first laser beam 205 to the beginning of a pulse of the second laser beam 250. The time delay may for example be 100 nanoseconds or more. The time delay may for example be 5 microseconds or less. The time delay may be beneficial in that the plasma generated by vaporization of the fuel droplet may have begun to decay before the second laser beam 250 is incident at the plasma generation location 201. The plasma may be absorbing of the second laser beam 250, and if it were present might therefore reduce the intensity of radiation of the second laser beam 250 incident upon the debris particles. An additional benefit of the time delay is that it allows time for the fuel droplet to break into pieces and for those pieces to separate from one another to some extent. Separation of the pieces from one another is desirable, since it reduces the likelihood that a second piece is located in the shadow of a first piece with respect to the second laser beam 250, and thus reduces the likelihood that the second laser beam is not incident upon the second piece.

Both the first laser beam 205 and the second laser beam 250 are pulsed laser beams. As mentioned further above, a delay between the beginning of a pulse of the first laser beam 205 and the beginning of a pulse of the second laser beam 250 may for example be 100 nanoseconds or more. In some instances, the duration of the pulse of the first laser beam 205 may be greater than 100 nanoseconds. Where this is the case, the first laser beam 205 may still be incident at the plasma generation location 201 when the second laser beam 250 is incident at the plasma generation location 201.

In an embodiment the delay may be measured in terms of the time elapsed after ignition of the plasma by the first laser beam 205. The delay may for example be less than about 2 microseconds after ignition of the plasma by the first laser beam 205.

The duration of the pulse of the second laser beam 250 may be selected based upon an understanding of the speed at which debris particles 252 travel away from the plasma generation location 201. For example, the duration of the pulse of the second laser beam 250 may be longer than the time required for all debris particles 252 to travel outside of the diameter of the second laser beam (i.e., to travel beyond the second laser beam).

The second laser beam 250 may comprise a single pulse incident at the plasma generation location 201 after a pulse of the first laser beam 205. Alternatively, the second laser beam 250 may comprise a plurality of pulses incident at the plasma generation location 201 after a pulse of the first laser beam 205. Absorption of the second laser beam 250 by debris particles may increase nonlinearly with the peak intensity of the second laser beam. The intensity of the second laser beam 250 may be increased by reducing the pulse duration of the second laser beam. However, as explained above, it may be desirable to illuminate the plasma generation location with the second laser beam 250 for a time that is longer than the time required for all debris particles 252 to travel outside of the diameter of the second laser beam. The second laser beam 250 may be provided as a series of pulses. The series of pulses may have a time duration that is desirable from the point of view of illuminating debris particles 252 at the plasma generation location 201 for the period taken for them to travel outside of the diameter of the second laser beam. The pulse duration may for example be a tenth of the time duration of the series of pulses or less, may be one hundredth of the time duration of the series of pulses or less, or may be one thousandth of the time duration of the series of pulses or less.

The second laser beam 250 may for example have a pulse duration of 10 nanoseconds or greater. The second laser beam may for example have a pulse duration of 10 microseconds or less.

The energy density of second laser beam 250 radiation incident upon a debris particle 252 may for example be 4 J/cm² or greater. This may be sufficient to vaporize a debris particle (e.g., tin) with a diameter of 0.5 microns within 8 nanoseconds. The energy density of second laser beam 250 radiation incident upon a debris particle 252 may for example be 16 J/cm² or greater. This may be sufficient to vaporize a debris particle (e.g., tin) with a diameter of 2 microns within 33 nanoseconds.

The second laser beam 250 may for example have provide a series of pulses that has a duration of 10 microseconds or less.

The pulse of the second laser beam 250 may have a conventional shape as a function of time, for example a Gaussian shape. Alternatively, the pulse of the second laser beam 250 may have a non conventional shape, for example a non-symmetric shape in which the rising edge of the pulse is longer than the falling edge of the pulse. The effect of the longer rising edge will be that lower intensity radiation is initially incident upon debris particles. As mentioned further above, debris particles that are initially generated may be small particles arising from ablation from the fuel droplet. The relatively low intensity at the rising edge of the radiation pulse may be sufficient to vaporize these small debris particles.

The delay between the beginning of the pulse of the first laser beam 205 and the beginning of the pulse of the second laser beam 250, and the duration of the pulse of the second laser beam 250, may be such that the pulse of the second laser beam has ended before the next pulse of the first laser beam 205 is incident at the plasma generation location 201. Successive pulses of the first laser beam 205 may for example be separated by 20 microseconds or more.

In addition to representing the time delay between a pulse of the first laser beam 205 and a pulse of the second laser beam 250, FIGS. 3 and 4 also schematically represent differences in diameters between the first laser beam 205 and the second laser beam 250. The first laser beam 205 is focused tightly at the plasma generation location 201 (focusing optics are omitted for ease of illustration) in order to maximise the proportion of the first laser beam that is incident upon the fuel droplet. The fuel droplet may for example have a diameter of the order of 10 microns, and the first laser beam 205 may have a similar diameter. In contrast to this, the second laser beam 250 is not required to have a tight focus at the plasma generation location. Instead, the second laser beam 250 may have a diameter that is sufficiently large that it is incident upon a significant proportion of debris particles.

The second laser beam 250 may for example have a diameter at the plasma generation location 201, which is 0.4 mm or greater, may for example have a diameter at the plasma generation location that is 1 mm or greater, and may for example have a diameter at the plasma generation location that is 2 mm or greater. The second laser beam 250 may for example have a diameter at the plasma generation location 201, which is 6 mm or less. The second laser beam 250 may for example be about 1 mm² at the plasma generation location 201.

The wavelength of the second laser beam 250 may have an effect on the efficiency with which debris particles are vaporized. Although it is not certain whether this is the case, it may be that if a debris particle has a diameter that is significantly smaller than the wavelength of the second laser beam 250, then the efficiency of absorption of the second laser beam by that debris particle is reduced. Therefore, it may be advantageous to provide the second laser beam 250 at a wavelength that is shorter than, or substantially equal to, the diameter of the smallest debris particles that it is desired to vaporize using the second laser.

It may be the case that it is not desired to vaporize debris particles that have a diameter below a minimum threshold diameter. The minimum threshold diameter may for example be 300 nanometres. Other mechanisms such as a gas flow debris mitigation system, or a foil trap, may be used to keep these small debris particles away from the collector CO or other optical surfaces of the lithographic apparatus. An example of a foil trap that may be used is described in U.S. Pat. No. 6,359,969, which is incorporated by reference herein in its entirety.

In some instances, the second laser beam 205 may not fully vaporize some debris particles, but may instead merely reduce them in size. Where this occurs, other mechanisms keep the reduced in size debris particles away from the collector CO or other optical surfaces of the lithographic apparatus.

The wavelength of the second laser beam 250 may for example be 100 nanometres or greater. The wavelength of the second laser beam 250 may for example be 10 microns or less. The wavelength of the second laser beam 250 may be different from the wavelength of the first laser beam 205. The second laser beam may for example be generated by an excimer laser (e.g., with a wavelength of 157 nanometres), an ArF laser, a KrF laser, a NdYAG laser, or any other suitable laser. The laser may for example be capable of generating a laser beam with a power of 0.1 kW or greater. The laser may for example be capable of generating a laser beam with a power of up to 10 kW.

Some optics that are used by the first laser beam 205 may also be used by the second laser beam 250. This may introduce some aberration into the second laser beam 250. However, this aberration may have an insignificant effect on the second laser beam since the second laser beam is not tightly focused (as explained further above).

The first laser beam 205 and the second laser beam 250 may be generated using respective first and second laser beam sources. Each laser beam source may for example comprise a laser and may in addition comprise one or more optical components configured to deliver the laser beam to the radiation generation location 201.

In an embodiment, the first laser beam 205 and the second laser beam 250 may be generated using the same laser. This may for example be achieved by using a first transition in the gain medium of the laser to generate the first laser beam 205 and using a second transition in the gain medium of the laser to generate the second laser beam 250 (the first and second transitions giving rise to photons of different energies). In this embodiment, the same laser may form part of the first laser beam source and may form part of the second laser beam source.

In an embodiment, the beam stop 251 may be replaced by a mirror (e.g., a focussing mirror) that is configured to reflect the second laser beam 250. The mirror may reflect the part of the second laser beam 250 that is not absorbed by debris particles 252 back towards the plasma generation location 201. The second laser beam 250 will thus be incident for a second time on the debris particles. In an embodiment, a second mirror may be positioned such that the second laser beam 250 is reflected by the second mirror and passes back through the plasma generation location 201 again. The two mirrors may for example provide a plurality of passes of the second laser beam 250 through the plasma generation location 201. The number of passes of the second laser beam 250 through the plasma generation location may for example be 2 or more, 5 or more, or 10 or more. The two mirrors may for example form an open resonator.

Embodiments of the invention may be considered to provide an irradiation system constructed and arranged to irradiate fuel material at a plasma generation location to vaporize or reduce the size of particles of the fuel material present at the plasma generation location. The irradiation system may be considered to comprise the laser that generates the second laser beam.

References to debris particles being vaporized may be considered to include evaporation of the debris particles.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The term “lens”, where the context allows, may refer to any one or combination of various types of optical components, including refractive, reflective, magnetic, electromagnetic and electrostatic optical components.

The term “EUV radiation” may be considered to encompass electromagnetic radiation having a wavelength within the range of 5-20 nm, for example within the range of 13-14 nm, or example within the range of 5-10 nm such as 6.7 nm or 6.8 nm

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g., semiconductor memory, magnetic or optical disk) having such a computer program stored therein. The descriptions above are intended to be illustrative, not limiting. Thus it will be apparent to one skilled in the art that modifications may be made to the invention as described without departing from the scope of the claims set out below.

1. An EUV radiation source, comprising:
a fuel supply configured to deliver a droplet of fuel to a plasma generation location;
a first laser beam source configured to provide a first beam of laser radiation that is incident upon the fuel droplet at the plasma generation location and thereby vaporizes the fuel droplet to generate an EUV radiation emitting plasma; and
a second laser beam source configured to subsequently provide a second beam of laser radiation at the plasma generation location, the second beam of laser radiation being configured to vaporize debris particles arising from incomplete vaporization of the fuel droplet.

2. The EUV radiation source of claim 1, wherein the first laser beam source is configured to provide the first beam of laser radiation as a pulsed beam, and the second laser beam source is configured to provide the second beam of laser radiation as a pulsed beam.

3. The EUV radiation source of claim 2, wherein the first and second laser beam sources are further configured such that the beginning of a radiation pulse of the second beam of laser radiation is incident at the plasma generation location 100 nanoseconds or more after the beginning of a radiation pulse of the first beam of laser radiation.

4. The EUV radiation source of claim 2, wherein the second laser beam source is configured such that a radiation pulse of the second beam of laser radiation is incident at the plasma generation location after a plasma formed by vaporization of the fuel droplet has decayed.

5. The EUV radiation source of claim 4, wherein the first and second laser beam sources are configured such that a radiation pulse of the second beam of laser radiation has ended before a subsequent radiation pulse of the first beam of laser radiation is incident at the plasma generation location.

6. The EUV radiation source of claim 4, wherein the second laser beam source is configured to provide the second beam of laser radiation as a series of radiation pulses.

7. The EUV radiation source of claim 6, wherein the first and second laser beam sources are further configured such that the series of radiation pulses of the second beam of laser radiation have ended before a subsequent radiation pulse of the first beam of laser radiation is incident at the plasma generation location.

8. The EUV radiation source of claim 7, wherein the second laser beam source is configured such that the duration of a radiation pulse of the second beam of laser radiation is a tenth of the duration of the series of radiation pulses or less.

9. The EUV radiation source of claim 1, wherein the second laser beam source is configured such that second beam of laser radiation has a diameter of 0.4 mm or more at the plasma generation location.

10. The EUV radiation source of claim 1, wherein the second laser beam source is configured such that second beam of laser radiation has a diameter of 6 mm or less at the plasma generation location.

11. The EUV radiation source of claim 1, wherein the second laser beam source is configured such that the second beam of laser radiation subtends an angle of 30° or less relative to an optical axis of the EUV radiation source.

12. The EUV radiation source of claim 1, further comprising a mirror configured to reflect the second beam of laser radiation such that the second beam of laser radiation passes through the plasma generation location two or more times.

13. The EUV radiation source of claim 12, further comprising an additional mirror configured to reflect the second beam of laser radiation such that it passes through the plasma generation location three or more times.

14. A lithographic apparatus comprising:
an EUV radiation source having a fuel supply configured to deliver a droplet of fuel to a plasma generation location, a first laser beam source configured to provide a first beam of laser radiation that is incident upon the fuel droplet at the plasma generation location and thereby vaporizes the fuel droplet to generate an EUV radiation emitting plasma, and a second laser beam source configured to subsequently provide a second beam of laser radiation at the plasma generation location, the second beam of laser radiation being configured to vaporize debris particles arising from incomplete vaporization of the fuel droplet;
an illumination system configured to condition an EUV radiation beam generated by the EUV radiation source;
a support constructed to support a patterning device, the patterning device being capable of imparting the EUV radiation beam with a pattern in its cross-section to form a patterned radiation beam;
a substrate table constructed to hold a substrate; and
a projection system configured to project the patterned EUV radiation beam onto a target portion of the substrate.

15. A method of generating EUV radiation, comprising:
delivering a droplet of fuel to a plasma generation location;
directing a first beam of laser radiation at the plasma generation location to vaporizing the fuel droplet and thereby generate an EUV radiation emitting plasma; and
directing a second beam of laser radiation at the plasma generation location to vaporize debris particles arising from incomplete vaporization of the fuel droplet.
